(19) United States
(12) Patent Application Publication
(10) Pub. No.: US 2026/0025744 A1
(43) Pub. Date: Jan. 22, 2026

(54) Method and Device for transmitting multi-link information, and Storage Medium

(71) Applicant: Aegis 11 S.A., Howald (LU)

(72) Inventor: Hao WU, Chengdu (CN)

(21) Appl. No.: 19/254,681

(22) Filed: Jun. 30, 2025

Related U.S. Application Data
(63) Continuation of application No. 18/033,554, filed on Apr. 25, 2023.

(30) Foreign Application Priority Data
Nov. 2, 2020 (CN) 202011202886.X

(51) Int. Cl. H04W 48/16; H04W 88/06

(52) U.S. Cl. CPC H04W 48/16; H04W 88/06

(57) ABSTRACT

The embodiments of the present disclosure discloses a method for transmitting multi-link information and device, and a storage medium, which relate to the field of wireless communications. The method includes: RNR information is sent, wherein the RNR information includes an MLD parameter, the MLD parameter includes an MLD ID field, a Link ID field and a Change Sequence field; A first message is sent, wherein the first message includes the RNR information; and after receiving the first message, performing, by a terminal, an operation according to the MLD parameter therein. In the embodiments of the present disclosure, by means of expanding the RNR information, the scenario of a multi-link network access device is satisfied without changing the existing mechanism. After receiving the message including the RNR information, the terminal may identify, according to the MLD parameter in the RNR information, whether a reported network access device belongs to the same multi-link network access device as the currently connected network access device, and performs a corresponding operation according to the MLD parameter. In addition, the setting method of the MLD parameter in the embodiments of the present disclosure is simple, easy to operate and high in practicability.

### PRIORITY CLAIM

The present application is a Continuation Application of U.S. application Ser. No. 18/033,554, filed Apr. 25, 2023, which is a National Phase Entry of PCT Application PCT/CN2021/106639, filed Jul. 16, 2021, which claims priority from CN patent application No. 202011202886.X, filed Nov. 2, 2020, each of which is hereby fully incorporated herein by reference.

### TECHNICAL FIELD

The present disclosure relates to the field of wireless communications, and in particular to a method for transmitting multi-link information and device, and a storage medium.

### BACKGROUND

An 802.11 be network, also known as an Extremely High-Throughput (EHT) network, realizes extremely high throughput by means of a series of system characteristics and a plurality of mechanism enhancement function. As the use of wireless local area networks (WLANs) continues to grow, it is increasingly important to provide wireless data services in many environments (e.g., homes, enterprises and hotspots). In particular, video traffic will continue to be the primary traffic type in many WLAN deployments. Due to the presence of 4k and 8k videos (uncompressed rates of 20 Gbps), throughput requirements of these applications are ongoing. With regard to novel high throughput such as virtual reality or augmented reality, games, remote offices and cloud computing, low-delay applications will surge (e.g., the delay of a real-time game is less than 5 milliseconds).

In view of the high throughput and strict real-time delay requirements of these applications, when a user desires to support his/her applications through the WLAN, the throughput is higher, the reliability is higher, the delay and jitter are less, and the power-supply efficiency is higher. The user desires to improve the integration with a time-sensitive network (TSN), so as to support applications on a heterogeneous Ethernet and the wireless LAN. The 802.11be network is intended to ensure the competitiveness of the WLAN by means of further increasing the overall throughput and reducing the delay, while ensuring backward compatibility and coexistence with old-version technology standards, for example, 802.11 compatible devices running at 2.4 GHZ, 5 GHz and 6 GHz bands.

### SUMMARY

In a first aspect, the embodiments of the present disclosure provide a method for transmitting multi-link information, including:

RNR information is sent, wherein the RNR information includes an MLD parameter, the MLD parameter includes an MLD ID field, a Link ID field and a Change Sequence field, the MLD ID field is used for identifying a multi-link network access device in a current message, the Link ID field is used for identifying a link in a multi-link network access device or multi-link terminal, and the Change Sequence field is used for indicating whether critical information is update in a current system message; and

A first message is sent, where in the first message includes the RNR information.

In some embodiments, the setting method of the MLD ID includes:
in a case that a reported second network access device belongs to the same multi-link network access device as a first network access device which sends the first message, setting the MLD ID to be a first value;
in a case that a second network access device does not belong to the same multi-link network access device as the first network access device, but a BSSID of the second network access device belongs to the same Multi BSSID set as the first network access device, setting the MLD ID to be a second value;
in a case that the second network access device does not belong to the same multi-link network access device as the first network access device, and the BSSID of the second network access device does not belong to the same Multi BSSID set as the first network access device, setting the MLD ID to be a third value;
in a case that the second network access device is not a multi-link network access device, setting the MLD ID to be a fourth value; and
the first value, the second value, the third value, and the fourth value are different.

In some embodiments, the second value is equal to a BSSID index of the second network access device, and the BSSID index is used for identifying a network access device in one Multi BSSID set.

In some embodiments, the third value is an integer, and the value range of the third value is greater than Nmax and less than M, wherein Nmax is a maximum value of the BSSID that is allowed to be used by the Multi BSSID set, and M is a maximum integer represented by a number of bits used by the MLD ID.

In some embodiments, the first value and the fourth value are selected from two values of 0 and M, and M is the maximum integer represented by the number of bits used by the MLD ID.

In some embodiments, the Change Sequence is an integer, which is provided with a maximum value, and the setting method of the Change Sequence includes:
when the critical information is update in the first message, adding 1 to the value of the Change Sequence field, after reaching a maximum value, adding 1 to the maximum value, and setting a sum of the maximum value and 1 to be a minimum value for cyclic use.

In some embodiments, the RNR information further includes a Neighbor AP TBTT Offset parameter and a BSSID parameter, and the Neighbor AP TBTT Offset parameter is used for indicating a time difference between the first network access device and the second network access device for sending a target message, the BSSID parameter is used for indicating the BSSID of the second network access device.

In some embodiments, the MLD parameter, the Neighbor AP TBTT Offset parameter and the BSSID parameter are all includes in TBTT information in the RNR information.

In some embodiments, the critical information includes at least one of a contention access parameter, a power-saving parameter, an antenna configuration parameter, an operation frequency band parameter, a resource unit parameter.

In some embodiments, the first message is a broadcast message or a probe response message.

In some embodiments, the target message is a broadcast message.

In some embodiments, the method further includes:
receiving, by the terminal, the first message, and performing an operation according to the MLD parameter therein.

In some embodiments, the step of performing the operation according to the MLD parameter therein includes:
in a case that the MLD ID in the MLD parameter is the first value, reading, by the terminal, the Change Sequence field, if the value of the read Change Sequence field is the same as a locally saved value, not reading the target message of the second network access device, and if the value of the read Change Sequence field is different from the locally saved value, reading, by the terminal, the target message of the second network access device at a schedule time according to the value of the Neighbor AP TBTT Offset;
in a case that the MLD ID in the MLD parameter is the second value, reading, by the terminal, the target message of the second network access device at the schedule time according to the value of the Neighbor AP TBTT Offset, and setting a reading interval Tinterval for the target message of the second network access device locally after reading the target message;
in a case that the MLD ID in the MLD parameter is the third value, saving a read information; and
in a case that the MLD ID in the MLD parameter is the fourth value and the current terminal is a multi-link terminal, not saving the read information, and if the current terminal is a single-link terminal, saving the read information.

In some embodiments, the setting method of the reading interval Tinterval is:

$$Tinterval = N \times Beacon Interval ,$$

wherein, N is an integer, the value range thereof is greater than 2 and less than Nmax, Nmax is a maximum value of the BSSID that is allowed to be used by the Multi BSSID set, and Beacon Interval is the value of a parameter Beacon interval, which is read from the target message. The reading interval Tinterval is set to be N times of the Beacon Interval, the time interval of the terminal reading the target message is properly prolonged, such that the power consumption of the terminal may be reduced while ensuring that the terminal may read the updated critical information in time.

In a second aspect, the embodiments of the present disclosure provide a multi-link information transmission device, including:
an information setting unit, configured to set RNR information, wherein the RNR information includes an MLD parameter, the MLD parameter includes: an MLD ID field, a Link ID field and a Change Sequence field, the MLD ID field is used for identifying one multi-link network access device in the current message, the Link ID field is used for identifying one link in one multi-link network access device or multi-link terminal, and the Change Sequence field is used for indicating whether critical information is update in the current system message; and
a message sending unit, configured to send a first message, wherein the first message includes the RNR information.

In a third aspect, the embodiments of the present disclosure provide another multi-link information transmission device, wherein the device includes a processor and a memory, the memory stores at least one program code, and the at least one program code is loaded and performed by the processor, so as to implement the method for transmitting multi-link information in the first aspect or the possible implementations of the first aspect.

In a fourth aspect, the embodiments of the present disclosure provides a non-transitory storage medium, wherein at least one program code is stored in the non-transitory storage medium, and the at least one program code is loaded and performed by a processor, so as to implement the method for transmitting multi-link information in the first aspect or the possible implementations of the first aspect.

It should be noted that, the device in the second aspect and the third aspect of the present disclosure, and the non-transitory storage medium in the fourth aspect are used for executing the method provided in the first aspect, so that the device may achieve the same beneficial effects as the method in the first aspect, and the embodiments of the present disclosure will not be described in detail one by one.

### BRIEF DESCRIPTION OF THE DRAWINGS

The embodiments of the present disclosure will be described by way of embodiments and with reference to the drawings, wherein:

FIG. 1 is a flowchart of a method for transmitting multi-link information according to an embodiment of the present disclosure.

### DETAILED DESCRIPTION OF THE EMBODIMENTS

In order that those skilled in the art may better understand the technical solutions in the present disclosure, a clear and complete description of the technical solutions in the embodiments of the present disclosure will be given below, in combination with the drawings in the embodiments of the present disclosure. Apparently, the embodiments described below are merely a part, but not all, of the embodiments of the present disclosure. It should be understood that, the specific embodiments described herein are merely used for explaining the present disclosure, and are not intended to limit the present disclosure. All of other embodiments, obtained by those ordinary skilled in the art based on the embodiments in the present disclosure without any creative effort, fall into the protection scope of the present disclosure. In addition, although the disclosure in the embodiments of the present disclosure has been described in terms of one or more exemplary examples, it should be understood that various aspects of these disclosure may also constitute a complete technical solution alone. In the case of no conflict, the following embodiments and features in the embodiments may be combined with each other.

In the embodiments of the present disclosure, words such as “exemplarily” and “for example” are used for representing an example, an illustration or a description. Any embodiment or design solution described as “an example” in embodiments of the present disclosure should not be construed as being more preferred or more advantageous than other embodiments or design solutions. Specifically, the use of the word example is intended to present concepts in a specific manner.

Unless otherwise defined, the technical terms or scientific terms used in the embodiments of the present disclosure should be usual meanings understood by those ordinary skilled in the art to which the embodiments of the present disclosure belongs. The terms “first”, “second” and similar words used in the embodiments of the present disclosure do not denote any order, quantity or importance, but are merely used for distinguishing descriptions, and the meanings of the corresponding terms may be the same or different. Similar words such as “including” or “containing” are intended to indicate that an element or object in front of the word encompasses elements or objects listed after the word and their equivalents, without excluding other elements or objects.

In an 802.11 wireless local area network, in order to facilitate and improve a terminal to search for an access point, or quickly find a suitable access point during a roaming process, so as to shorten a data interruption time caused by roaming, RNR (Reduced Neighbor Report) information is sent to the terminal by means of an access point that is currently connected to the terminal, and the RNR information includes information such as a BSSID parameter, an SSID parameter, or a BSS parameter of an adjacent access point, and is used for providing information for an access point, which is in the vicinity of the terminal and may be connected to the terminal, so as to help the terminal to implement quick connection during network recovery or roaming. However, in a multi-link scenario, the type of the access point is relatively complex, for example, one multi-link access point (AP MLD) may be only one physical device, while logically supporting three running APs, such APs may be configured to have different BSSIDs, but the same SSID and BSS parameters, or have some different BSS parameters. When the terminal accesses to one logical AP of the AP MLD, since this terminal may be a single-link terminal or a multi-link terminal, the terminal may not access to other logical APs at the same time. Therefore, there is a need in the RNR information to distinguish information transmission in a complex AP MLD scenario. In view of this, The present invention provides a multi-link information transmission method and device.

The technical solutions in the embodiments of the present disclosure will be described below in combination with the drawings.

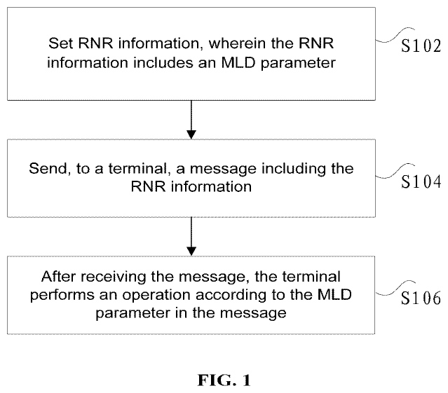

FIG. 1 is a flowchart of a method for transmitting multi-link information according to an embodiment of the present disclosure. As shown in FIG. 1, the method for transmitting multi-link information includes the following steps:
S101, RNR information is sent, wherein the RNR information includes an MLD parameter, and a setting example of the MLD parameter is shown in Table 1.

TABLE 1

| | | |
|---|---|---|
| MLD ID | Link ID | Change Sequence |

Wherein,

MLD ID is used for identifying a multi-link network access device in a current message.

Exemplarily, the setting method of the MLD ID includes:
in a case that a reported second network access device belongs to the same multi-link network access device as a first network access device which sends a first message, setting the MLD ID to be a first value;
in a case that a second network access device does not belong to the same multi-link network access device as the first network access device, but a BSSID of the second network access device belongs to the same Multi BSSID set as the first network access device, setting the MLD ID to be a second value;
in a case that the second network access device does not belong to the same multi-link network access device as the first network access device, and the BSSID of the second network access device does not belong to the same Multi BSSID set as the first network access device, setting the MLD ID to be a third value;
in a case that the second network access device is not a multi-link network access device, setting the MLD ID to be a fourth value; and
the first value, the second value, the third value, and the fourth value are different.

Link ID is used for identifying a link in a multi-link network access device or multi-link terminal.

Change Sequence is used for indicating whether critical information is update in a current system message. The critical information includes at least one of a contention access parameter, a power-saving parameter, an antenna configuration parameter, an operation frequency band parameter, a resource unit parameter.

In some embodiments, the RNR information further includes a Neighbor AP TBTT Offset parameter and a BSSID parameter, the MLD parameter, the Neighbor AP TBTT Offset parameter, the BSSID parameter may be includes in TBTT information in the RNR information, and a structure example thereof is shown in Table 2.

TABLE 2

| | | |
|---|---|---|
| Neighbor AP TBTT Offset | BSSID | MLD parameter |

Wherein,

Neighbor AP TBTT Offset is used for indicating a time difference of a reported second network access device for sending a target message compared with the first network access device that sends a message at present.

BSSID is used for indicating the BSSID of the reported network access device.

S102, a message is sent to a terminal, the message including the RNR information. For example, the sent message may be messages such as a broadcast message or a probe response message.

S103, after received the message, the terminal performs an operation according to the MLD parameter in the message.

Exemplarily, the terminal performing the operation according to the MLD parameter in the message includes:
in a case that the MLD ID in the MLD parameter is the first value, reading, by the terminal, the Change Sequence field, if the value of the read Change Sequence field is the same as a locally saved value, not reading the target message of the second network access device, and if the value of the read Change Sequence field is different from the locally saved value, reading, by the terminal, the target message of the second network access device at a schedule time according to the value of the Neighbor AP TBTT Offset;
in a case that the MLD ID in the MLD parameter is the second value, reading, by the terminal, the target message of the second network access device at the schedule time according to the value of the Neighbor AP TBTT Offset, and setting a reading interval Tinterval for the target message of the second network access device locally after reading the target message;
in a case that the MLD ID in the MLD parameter is the third value, saving a read information; and
in a case that the MLD ID in the MLD parameter is the fourth value and the current terminal is a multi-link terminal, not saving the read information, and if the current terminal is a single-link terminal, saving the read information.

By means of expanding the RNR information, the scenario of the multi-link network access device is satisfied without changing the existing mechanism. After receiving the message including the RNR information, the terminal may identify, according to the MLD parameter in the RNR information, whether the reported network access device belongs to the same multi-link network access device as the currently connected network access device, and performs a corresponding operation according to the MLD parameter. In addition, the setting method of the MLD parameter in the embodiments of the present disclosure is simple, easy to operate and high in practicability.

The embodiments of the present disclosure will be further described below with reference to a specific embodiment. In the specific embodiment, STA MLD represents a multi-link terminal, the multi-link terminal includes a plurality of logical entities STAs, each logical entity STA respectively performs data transmission through one link, and each logical entity STA includes an independent data transceiving component. The link is a radio resource for transmitting data. AP MLD represents a multi-link access point, the multi-link access point includes a plurality of logical APs, each logical AP respectively performs data transmission through one link, and each logical AP includes an independent data transceiving component.

Those skilled in the art will appreciate that, according to the principles and functions described in the present disclosure, the term “AP” according to the embodiments of the present disclosure may also be used for describing an access port or any other device, which is capable of receiving and transmitting wireless signals within a network architecture. Thus, the use of a wireless access point is merely exemplary.
1. An AP sends a broadcast message Beacon frame, the message includes RNR information, wherein the RNR information includes TBTT information, the TBTT refers to a target Beacon frame sending time, the TBTT information includes an MLD parameter, and exemplarily, the settings of the TBTT information are shown in Table 3.

TABLE 3

| | | |
|---|---|---|
| Neighbor AP TBTT Offset | BSSID | MLD parameter |

Wherein,

Neighbor AP TBTT Offset is used for indicating a time difference of a reported AP for sending a Beacon frame compared with an AP that sends the Beacon frame at present;

BSSID is used for indicating the BSSID of the reported AP; and

the settings of the MLD parameter are shown in Table 4.

TABLE 4

| | | |
|---|---|---|
| MLD ID | Link ID | Change Sequence |

Wherein,
MLD ID is used for identifying one AP MLD in the current message;
Link ID is used for identifying one link corresponding to the currently reported AP in one AP MLD; and
Change Sequence is an integer, when critical information is update on the Beacon frame, 1 is added to this number, a maximum value is set, and after reaching the maximum value, 1 is added to the maximum value, and a sum of the maximum value and 1 is set to be a minimum value for cyclic use.

The settings of the MLD ID are as follows:
if the reported AP belongs to the same AP MLD as the AP that sends the Beacon frame, the MLD ID=0.

If the reported AP does not belong to the same AP MLD as the AP that sends the Beacon frame, but the BSSID of the reported AP belongs to the same Multi BSSID set as the AP that sends the Beacon frame, the MLD ID=BSSID index, wherein the BSSID index is used for identifying one AP in one Multi BSSID set. Exemplarily, one Multi BSSID set has the following three BSSIDs: 0E-7A-15-E6-5C-30, 0E-7A-15-E6-5C-34 and 0E-7A-15-E6-5C-35, the values of the last four bits of an address are the indexes of the BSSID, and the indexes of the three addresses are respectively 0, 4 and 5.

If the reported AP does not belong to the same AP MLD as the AP that sends the Beacon frame, and the BSSID of the reported AP does not belong to the same Multi BSSID set as the AP that sends the Beacon frame, which is simply referred to as the reported AP belonging to another AP MLD, the MLD ID=Ni; and Ni is an integer, the value range the third value is greater than Nmax and less than M, wherein Nmax is a maximum value of the BSSID which is allowed to be used by the Multi BSSID set, and M is a maximum integer represented by the number of bits used by the MLD ID.

Examples are as follows:

If 8 bits are used for identifying the MLD ID, M=256, the maximum value allowed by the Multi BSSID set is 8, then Nmax=8, then the MLD ID of the first other AP MLD that needs to be reported is set to be 9, the MLD ID of the second other AP MLD that needs to be reported is set to be 10, and so on, the MLD ID of the third other AP MLD is set to be 11, thereby ensuring that the MLD ID of each other AP MLD is different in the message.
4) When the reported AP is not an AP MLD, the MLD ID=M.
2. After receiving an RNR message in the Beacon frame, the terminal performs an operation according to the MLD parameter therein:
if the reported AP belongs to the same AP MLD as the AP that is currently connected to the terminal, the terminal reads a Change Sequence parameter, if the value of the read Change Sequence parameter is the same as a locally saved value, the terminal does not read a Beacon message of the AP, and if the value of the read Change Sequence parameter is different from the locally saved value, the terminal reads the Beacon message of the AP at a schedule time according to the value of the Neighbor AP TBTT Offset.

If the reported AP does not belong to the same AP MLD as the AP that is currently connected to the terminal, but the reported AP belongs to the same Multi BSSID set as the AP that is currently connected to the terminal, the terminal reads the Beacon message of the AP at the schedule time according to the value of the Neighbor AP TBTT Offset, and sets a Beacon reading interval Tinterval of the AP locally after reading the Beacon message. Exemplarily, Tinterval=N×Beacon Interval, wherein the value range of N is greater than 2 and less than Nmax, and the Beacon Interval is the value of a Beacon interval parameter read from the Beacon message.

If the reported AP is another AP MLD, the read information is saved.

If the reported AP is a non-AP MLD, if the current terminal is a multi-link terminal, the read information is not stored, and if the current terminal is a single-link terminal, the read information is saved.

The embodiments of the present disclosure further provide a multi-link information transmission device, wherein the device is used for implementing the method for transmitting multi-link information involved in the foregoing embodiments, may be implemented by hardware, and may also be implemented by hardware executing corresponding software. The hardware or software includes one or more units corresponding to the foregoing functions, for example, an information setting unit, a message sending unit, and the like.

The embodiments of the present disclosure further provide a multi-link information transmission device, wherein the device includes a processor and a memory, the memory stores at least one program code, and the at least one program code is loaded and performed by the processor, so as to implement the method for transmitting multi-link information involved in the above embodiments.

The embodiments of the present disclosure further provide a computer readable storage medium, wherein at least one program code is stored in the non-transitory storage medium, and the at least one program code is loaded and performed by a processor, so as to implement the method for transmitting multi-link information involved in the above embodiments.

It should be understood that, in various embodiments of the present disclosure, the sizes of the serial numbers of the above processes do not mean an execution sequence, some or all steps may be performed in parallel or successively, and the execution sequence of the processes is determined by the functions and internal logic, and should not constitute any limitation to the implementation process of the embodiments of the present disclosure.

Those ordinary skilled in the art may be aware that, units and algorithm steps of various examples described in combination with the embodiments disclosed herein may be implemented by electronic hardware, or a combination of computer software and electronic hardware. Whether these functions are performed by hardware or software depends on specific applications and design constraint conditions of the technical solutions. Those skilled in the art may use different methods for each particular application to implement the described functions, but this implementation should not be considered as exceeding the scope of the present disclosure.

Those skilled in the art to which the embodiments of the present disclosure belongs may clearly understand that, for the convenience and brevity of description, with regard to the specific working processes of the systems, devices and components described above, reference may be made to corresponding processes in the foregoing method embodiments, and thus details are not described herein again.

In the several embodiments provided by the present disclosure, it should be understood that the disclosed systems, devices and methods may be implemented in other manners. For example, the device embodiments described above are merely illustrative, for example, the division of the components is only a logical function division, there may be other division manners in practical implementation, for example, a plurality of components or components may be combined or integrated to another system, or some features may be omitted or not implemented. For example, the flowcharts and block diagrams in the drawings illustrate system architectures, functions and operations, which may be implemented by the devices, methods and computer program products according to a plurality of embodiments of the present disclosure. In this regard, each block in the flowcharts or block diagrams may represent a part of a component, program segment or code, and the part of the component, program segment or code includes one or more executable instructions for implementing schedule logical functions. It should also be noted that, in some alternative implementations, the functions annotated in the block may occur out of the order annotated in the drawings. For example, two consecutive blocks may, in fact, be performed substantially in parallel, and may also sometimes be performed in a reverse order, depending on the functions involved. It should also be noted that, each block in the block diagrams and/or flowcharts, and combinations of the blocks in the block diagrams and/or flowcharts may be implemented by using dedicated hardware-based systems for performing schedule functions or actions, or may be implemented by using combinations of dedicated hardware and computer instructions. From another point of view, the displayed or discussed mutual coupling or direct coupling or communication connection may be indirect coupling or communication connection of devices or components through some interfaces, and may be in electrical, mechanical or other forms.

The components described as separate components may be separated physically or not, components displayed as components may be physical components or not, namely, may be located in one place, or may be distributed on a plurality of network units. A part of or all of the components may be selected to implement the purposes of the solutions in the present embodiment according to actual demands.

In addition, various functional components in various embodiments of the present disclosure may be integrated in one processing unit, or the components individually exist physically, or two or more components are integrated in one unit.

If the function is implemented in the form of a software functional component and is sold or used as an independent product, it may be stored in a non-transitory storage medium. Based on this understanding, the technical solutions of the embodiments of the present disclosure substantially, or the part contributing to the prior art, or part of the technical solutions may be implemented in the form of a software product, the computer software product is stored in a storage medium, which includes several instructions for enabling a computer device (which may be a personnel computer, a server, a network device or a terminal device or the like) to perform all or part of the steps of the method in the various embodiments of the present disclosure. The foregoing storage medium includes a variety of media capable of storing program codes, such as a USB disk, a mobile hard disk drive, an ROM, an RAM, a magnetic disk, or an optical disk.

The terms used in the embodiments of the present disclosure are for the purpose of describing particular embodiments only and are not intended to limit the present disclosure. As used in the embodiments of the present disclosure and the appended claims, singular forms “a”, “said” and “the” are also intended to include plural forms, unless the context clearly indicates other meanings. It should also be understood that, the term “and/or” as used herein refers to and includes any or all possible combinations of one or more associated listed items. As used herein, the character “/” generally indicates that front and back associated objects have an “or” relationship.

Depending on the context, the word “if” or “in the case of” as used herein may be interpreted as “when” or “upon” or “in response to determining” or “in response to detecting”. Similarly, depending on the context, the phrase “if it is determined that” or “if it is detected that (stated conditions or events)” may be interpreted as “when it is determined that” or “in response to determining that” or “when it is detected that (stated conditions or events)” or “in response to detecting that (stated conditions or events)”.

The foregoing descriptions are merely specific embodiments of the present disclosure, but the protection scope of the embodiments of the present disclosure is not limited thereto. Changes or replacements, which may be easily conceived by anyone who is familiar with this art within the technical scope disclosed in the present disclosure, shall fall within the protection scope of the present disclosure. Therefore, the protection scope of the embodiments of the present disclosure shall be subject to the protection scope of the claims.

1. A method for transmitting multi-link information comprising:
setting Reduced Neighbor Report (RNR) information, wherein the RNR information comprises an Multi-Link Device (MLD) parameter, the MLD parameter comprises an MLD ID field, a Link ID field and a Change Sequence field, the MLD ID field is used for identifying a multi-link network access device in a current message, the Link ID field is used for identifying a link in a multi-link network access device or multi-link terminal, and the Change Sequence field is used for indicating whether critical information is update; and
sending a first message, wherein the first message comprises the RNR information.

2. The method for transmitting multi-link information as claimed in claim 1, wherein the setting method of the MLD ID comprises:
in response to that a reported second network access device belongs to the same multi-link network access device as a first network access device which sends the first message, setting the MLD ID to be a first value;
in response to that a second network access device does not belong to the same multi-link network access device as the first network access device, but a Basic Service Set Identifier (BSSID) of the second network access device belongs to the same Multi BSSID set as the first network access device, setting the MLD ID to be a second value;
in response to that the second network access device does not belong to the same multi-link network access device as the first network access device, and the BSSID of the second network access device does not belong to the same Multi BSSID set as the first network access device, setting the MLD ID to be a third value;
in response to that the second network access device is not a multi-link network access device, setting the MLD ID to be a fourth value; and
the first value, the second value, the third value, and the fourth value are different.

3. The method for transmitting multi-link information as claimed in claim 2, wherein the second value is equal to a BSSID index of the second network access device, and the BSSID index is used for identifying a network access device in one Multi BSSID set.

4. The method for transmitting multi-link information as claimed in claim 2, wherein the third value is an integer, and the value range thereof is greater than Nmax and less than M, wherein Nmax is a maximum value of the BSSID that is allowed to be used by the Multi BSSID set, and M is a maximum integer represented by a number of bits used by the MLD ID.

5. The method for transmitting multi-link information as claimed in claim 2, wherein the first value and the fourth value are selected from two values of 0 and M, and M is the maximum integer represented by the number of bits used by the MLD ID.

6. The method for transmitting multi-link information as claimed in claim 1, wherein the Change Sequence is an integer, which is provided with a maximum value, and the setting method of the Change Sequence comprises:
when the critical information is update in the first message, adding 1 to the value of the Change Sequence field, after reaching a maximum value, adding 1 to the maximum value, and setting a sum of the maximum value and 1 to be a minimum value for cyclic use.

7. The method for transmitting multi-link information as claimed in claim 2, wherein the RNR information further comprises a Neighbor Access Point Target Beacon Transmission Time (AP TBTT) Offset parameter and a BSSID parameter, and the Neighbor AP TBTT Offset parameter is used for indicating a time difference between the first network access device and the second network access device for sending a target message, the BSSID parameter is used for indicating the BSSID of the second network access device.

8. The method for transmitting multi-link information as claimed in claim 7, wherein the MLD parameter, the Neighbor AP TBTT Offset parameter and the BSSID parameter are all comprises in TBTT information in the RNR information.

9. The method for transmitting multi-link information as claimed in claim 1, wherein the critical information comprises at least one of a contention access parameter, a power-saving parameter, an antenna configuration parameter, an operation frequency band parameter, a resource unit parameter.

10. The method for transmitting multi-link information as claimed in claim 1, wherein the first message is a broadcast message or a probe response message.

11. The method for transmitting multi-link information as claimed in claim 7, wherein the target message is a broadcast message.

12. The method for transmitting multi-link information as claimed in claim 7, further comprising:
receiving, by the terminal, the first message, and performing an operation according to the MLD parameter therein.

13. The method for transmitting multi-link information as claimed in claim 12, wherein the step of performing the operation according to the MLD parameter therein comprises:
in a case that the MLD ID in the MLD parameter is the first value, reading, by the terminal, the Change Sequence field, if the value of the read Change Sequence field is the same as a locally saved value, not reading the target message of the second network access device, and if the value of the read Change Sequence field is different from the locally saved value, reading, by the terminal, the target message of the second network access device at a schedule time according to the value of the Neighbor AP TBTT Offset;
in a case that the MLD ID in the MLD parameter is the second value, reading, by the terminal, the target message of the second network access device at the schedule time according to the value of the Neighbor AP TBTT Offset, and setting a reading interval Tinterval for the target message of the second network access device locally after reading the target message;
in a case that the MLD ID in the MLD parameter is the third value, saving a read information; and
in a case that the MLD ID in the MLD parameter is the fourth value and the current terminal is a multi-link terminal, not saving the read information, and if the current terminal is a single-link terminal, saving the read information.

14. The method for transmitting multi-link information as claimed in claim 13, wherein the setting method of the reading interval Tinterval is:
$$Tinterval = N \times Beacon Interval ,$$
wherein, N is an integer, the value range thereof is greater than 2 and less than Nmax, Nmax is a maximum value of the BSSID that is allowed to be used by the Multi BSSID set, and Beacon Interval is the value of a parameter Beacon interval, which is read from the target message.

15. A multi-link information transmission device, comprising:
an information setting unit, configured to set RNR information, wherein the RNR information comprises an MLD parameter, the MLD parameter comprises: an MLD ID field, a Link ID field and a Change Sequence field, the MLD ID field is used for identifying one multi-link network access device in the current message, the Link ID field is used for identifying one link in one multi-link network access device or multi-link terminal, and the Change Sequence field is used for indicating whether critical information is update; and
a message sending unit, configured to send a first message, wherein the first message comprises the RNR information.

16. A multi-link information transmission device, wherein the device comprises a processor and a memory, the memory stores at least one program code, and the at least one program code is loaded and performed by the processor, so as to implement the method for transmitting multi-link information as claimed in claim 1.

17. A non-transitory computer-readable storage medium, wherein at least one program code is stored in the non-transitory computer-readable storage medium, and the at least one program code is loaded and performed by a processor, so as to implement the method for transmitting multi-link information as claimed in claim 1.
